(19) United States
(12) Patent Application Publication
(10) Pub. No.: US 2026/0330441 A1
(43) Pub. Date: Oct. 22, 2026

(54) SMART GLASSES FOR PAYMENT AUTHENTICATION WITH POINT OF SALE TERMINALS

(71) Applicant: PopID, Inc., Diamond Bar, CA (US)

(72) Inventors: John Miller, Diamond Bar, CA (US); Ashish Gupta, Diamond Bar, CA (US); Sean Olson, Diamond Bar, CA (US)

(21) Appl. No.: 19/436,683

(22) Filed: Dec. 30, 2025

Related U.S. Application Data
(60) Provisional application No. 63/728,520, filed on Dec. 5, 2024.

(51) Int. Cl. G06Q 20/32; G06Q 20/20; G06Q 20/40; G06V 10/147; G06V 10/75; G06V 40/12

(52) U.S. Cl. CPC G06Q 20/321; G06Q 20/204; G06Q 20/40145; G06V 10/147; G06V 10/751; G06V 40/1359; G06V 40/1376

(57) ABSTRACT

Smart glasses, systems, and methods are disclosed for authenticating users and authorizing payment transactions through interaction between the smart glasses and payment terminals, such as retail point-of-sale terminals and electronic commerce devices. A smart glasses device includes a frame, a see-through display, at least one imaging camera, one or more processors, a memory storing biometric template data, and a wireless communication interface configured to exchange data with the payment terminals. The processors are configured to receive transaction data from a payment terminal, prompt the user via the see-through display to perform an authentication action, capture biometric data such as images of an inner surface of a palm, compare derived biometric feature data to stored template data, and, upon determining that the user is authenticated, cause a payment authorization message or payment token to be provided back toward the payment terminal or a payment service. In some embodiments, biometric matching is performed locally on the smart glasses, while in other embodiments raw palm images are transmitted to a cloud-based matching server. Further embodiments support RGB-only palm imaging, NIR palm imaging, multi-spectral imaging, and interaction with phones or tablets used for electronic commerce checkout.

### CROSS-REFERENCE TO RELATED APPLICATIONS

This application claims the benefit of U.S. Provisional Patent Application No. 63/728,520, filed Dec. 5, 2024, entitled “SMART GLASSES WITH PAYMENT CAPABILITIES,” the entire contents of which are incorporated herein by reference.

### FIELD OF THE INVENTION

The present disclosure relates generally to biometric authentication and electronic payment systems and, more particularly, to smart glasses that communicate with payment terminals, such as retail point-of-sale terminals and electronic commerce devices, to authenticate a user and authorize payment transactions, including embodiments that use palm images as a biometric factor.

### BACKGROUND

Consumers increasingly rely on electronic payments for purchases made in brick-and-mortar retail stores, restaurants, transportation hubs, and for electronic commerce transactions initiated on mobile devices and personal computers. Conventional payment methods require presentation of a card, a mobile phone, or another dedicated payment device at a merchant payment terminal or online checkout interface.

To improve security and user convenience, biometric authentication systems have been introduced that use facial images, fingerprints, iris patterns, or palm images to confirm the identity of a payer. Many of these systems employ fixed biometric sensors that are integrated into merchant payment terminals or kiosks. The user must align a face, finger, or palm with the fixed sensor, which may be ergonomically inconvenient, subject to lighting and height variations, and such identification systems are difficult to retrofit onto existing payment terminals that are not configured for biometric authentication.

Palm-based biometrics are attractive for payment use because the inner surface of the hand contains rich textural and vascular structure, is typically unobscured by cosmetics, and can be presented for authentication naturally. However, stationary palm readers mounted on countertops or kiosks may require the user to reach or lean in and may not be present at all merchants.

Smart glasses are head-mounted computing devices that resemble eyeglasses and can provide near-eye optical displays, cameras, inertial measurement units, wireless connectivity, and on-board processing. While smart glasses have been proposed for augmented reality, navigation, and communications, existing prior art designs do not provide integrated palm-based biometric payment functionality in which the glasses themselves serve as the primary biometric capture and payment authorization device.

It is desirable for a user to be able to authorize a payment by simply looking at transaction details presented in smart glasses and briefly presenting the palm for capture by a camera built into the glasses, without retrieving a wallet or phone and without touching merchant hardware. It is further desirable to enable such smart glasses to interact directly with a retail point-of-sale terminal at the merchant location and, in other embodiments, to interact with a mobile phone or tablet used for electronic commerce checkout.

There is therefore a need for improved systems and methods in which smart glasses capture palm images, locally or remotely authenticate a user using those palm images, and cooperate with retail payment terminals and e-commerce devices to authorize payments while protecting biometric data and payment account information.

### SUMMARY

In one aspect, a smart glasses device is provided that includes an eyeglass-type frame configured to be worn on a head of a user, the device comprising at least one transparent lens or waveguide element forming a see-through display, a palm imaging camera oriented to capture images of an inner surface of a palm of the user when the user presents the palm within a capture zone in front of the smart glasses device, one or more processors, a memory storing palm biometric template data, and a wireless communication interface. The processors execute instructions to receive transaction data, prompt the user via the see-through display to present the palm, capture one or more palm images, extract biometric features, compare the biometric features to the palm template data, and, upon a successful match, cause a payment authorization message to be transmitted to a payment service.

In one embodiment, the palm imaging camera is implemented as a visible-light red, green, blue (RGB) camera. Palm ridge and crease patterns and other texture features are extracted from RGB images and used for matching. In another embodiment, the palm imaging camera includes a near-infrared (NIR) sensor and cooperates with one or more NIR illumination sources to capture palm vein patterns. In a further embodiment, the imaging system is multi-spectral and captures both RGB and NIR images of the palm.

In some embodiments, the smart glasses perform biometric matching locally. The smart glasses store palm templates in secure memory, compare features extracted from newly captured palm images to the stored templates, and transmit only a signed authentication result or token to the payment service. In other embodiments, the smart glasses transmit at least one raw palm image, or an encoded representation of such an image, to a cloud-based matching server through the wireless functionality that performs biometric matching and returns an authentication decision. Both local and cloud matching embodiments can coexist in the same device and be selected based on policy or context.

In another aspect, a payment system is provided in which the smart glasses interact with a retail point-of-sale (POS) terminal. The POS terminal generates a payment request and communicates transaction details, such as a merchant identifier and transaction amount, to the smart glasses. The smart glasses capture a palm image and authenticate the user as described above, and then cause a payment credential or payment token to be supplied to the POS terminal or a remote payment network to complete the transaction.

In another aspect, the smart glasses interact with a user-operated device, such as a mobile phone or tablet used for e-commerce checkout. When the user confirms an online purchase on the phone or tablet, the phone or tablet requests biometric confirmation from the smart glasses. The smart glasses acquire a palm image from the user and return an authentication result to the phone or tablet, which then proceeds with payment completion.

In some embodiments, a see-through display of the smart glasses presents an augmented reality (AR) payment interface from the perspective of the wearer. The interface can show merchant and amount information, a graphic indicating where to position the palm, and an animation or icon confirming payment approval or denial.

Further embodiments, details, and variations will be apparent from the following description and drawings. The summary is provided to introduce certain concepts in simplified form and is not intended to limit the scope of the claimed invention.

### BRIEF DESCRIPTION OF THE FIGURES

FIG. 1 is a perspective view of a user wearing smart glasses and presenting an open palm in front of the user, with a virtual payment confirmation graphic overlaid near the palm to illustrate palm-based payment authorization.

FIG. 2 is a perspective view of the user wearing smart glasses and presenting a palm adjacent to a retail point-of-sale terminal, with payment status graphics indicating interaction between the smart glasses, the user's palm, and the terminal.

FIG. 3 is a perspective view similar to FIG. 2 showing a completed payment at the retail point-of-sale terminal, with the user's palm presented and the terminal display showing a successful payment indicator.

FIG. 4 is a block diagram of hardware components of an example smart glasses device, including a palm imaging camera, an optional NIR imaging subsystem, a processor, memory, a display subsystem, and a wireless interface.

FIG. 5 is a system-level block diagram illustrating interaction between the smart glasses, a retail POS terminal, a user-operated phone or tablet used for e-commerce, and a cloud-based biometric and payment service.

FIG. 6 is a flow diagram of an example enrollment process in which the smart glasses capture palm images and generate a palm biometric template for a user.

FIG. 7 is a flow diagram of an example payment authorization process in which the smart glasses capture a palm image, perform local or cloud-based biometric matching, and cooperate with a payment terminal or e-commerce device to complete a payment transaction.

FIG. 8 is a schematic illustration of an example field-of-view of the smart glasses as perceived by the wearer, showing an augmented reality overlay of merchant information, transaction amount, and a palm positioning guide used during palm-based payment authorization.

The figures provided herein are illustrative and not necessarily to scale.

### DETAILED DESCRIPTION

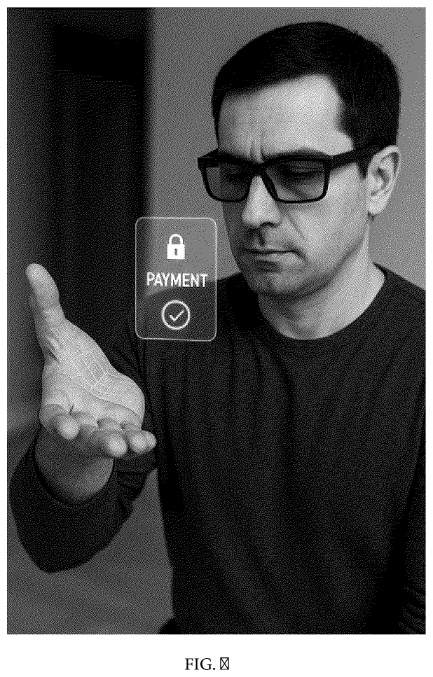

Referring to FIG. 1, a user 100 wears smart glasses 102 on the user's head. The smart glasses 102 include a frame that supports left and right transparent lenses or waveguides positioned in front of the user's eyes, and one or more cameras and illumination sources integrated into the frame. In the illustrated example, the user 100 holds an open palm 104 facing upward in front of the user's torso. A virtual payment indicator, such as an icon depicting a locked padlock and the word “PAYMENT” with a check mark, is projected by the smart glasses 102 in proximity to the palm 104 to represent that the smart glasses 102 are capturing an image of the palm and authorizing a payment based on the palm biometrics.

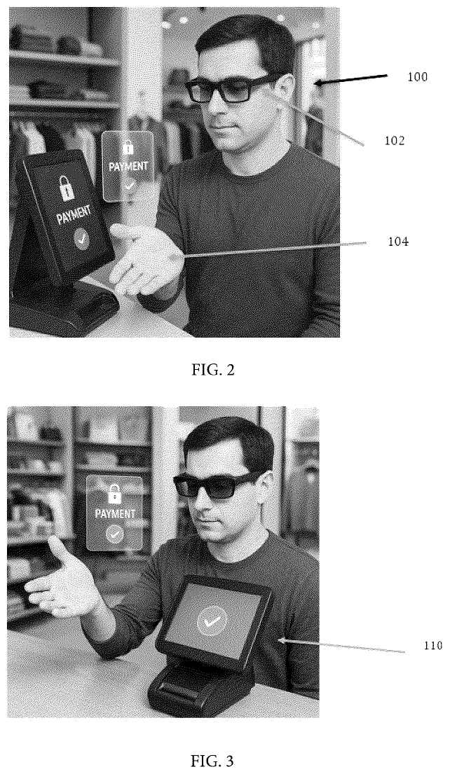

FIG. 2 depicts a similar user 100 wearing the smart glasses 102 and presenting the palm 104 adjacent to a merchant point-of-sale terminal 110. The terminal 110 includes a display screen that may show payment status, while a virtual payment graphic projected by the smart glasses 102 near the palm illustrates that the palm capture performed by the smart glasses 102 is being used to complete a transaction at the POS terminal 110. As discussed below, the smart glasses 102 can communicate directly with the POS terminal 110 or with a backend payment service in order to supply a payment token or authorization message once the user 100 has been authenticated.

FIG. 3 illustrates another view of the user 100, palm 104, smart glasses 102, and POS terminal 110. The POS terminal display may show a large check mark or other indicator of successful payment, and the virtual payment graphic near the palm 104 may indicate that the payment has been approved. FIGS. 2 and 3 together illustrate an embodiment in which the smart glasses 102 are explicitly used to authenticate the user and confirm payment at a retail payment terminal located at a merchant point of sale.

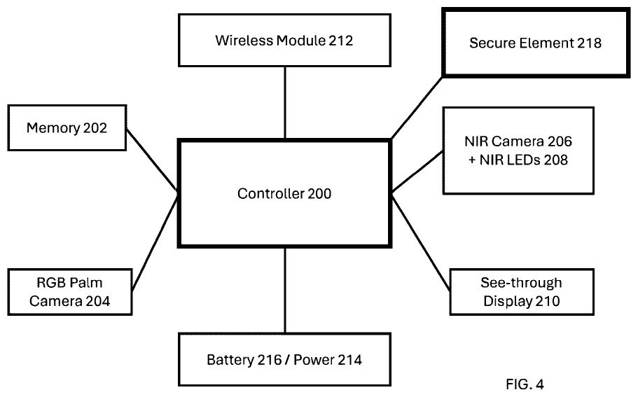

FIG. 4 shows an embodiment of the hardware architecture of the smart glasses 102. A controller 200 includes one or more processors and is coupled to a memory 202 storing executable instructions, palm biometric templates, and temporary image data. A visible-light palm imaging camera 204, such as an RGB camera, is mounted to the frame and oriented to capture images of the palm 104 within a capture zone located in front of the smart glasses 102. In an RGB-only embodiment, the palm imaging subsystem comprises only the camera 204 and an associated lens.

In another embodiment, the palm imaging subsystem further includes a near-infrared camera 206 and one or more near-infrared illumination sources 208. The NIR camera 206 may share optics with or be separate from the RGB camera 204. The controller 200 can operate in an NIR mode to capture palm vein patterns under NIR illumination, or in a combined RGB-plus-NIR mode in which both surface and sub-surface palm features are captured.

The controller 200 also interfaces with a see-through display subsystem 210 that renders text and graphics in the user's field of view, including the transaction prompts and confirmations described herein. A wireless communication module 212 supports communication over one or more protocols, such as Bluetooth Low Energy, Wi-Fi, or a cellular modem. A power management unit 214 supplies operating power from a rechargeable battery 216.

In some embodiments, a secure element 218 or trusted execution environment is provided and configured to store palm biometric templates and cryptographic keys. Authentication operations and signing of payment tokens may be performed within the secure element 218 to protect sensitive data.

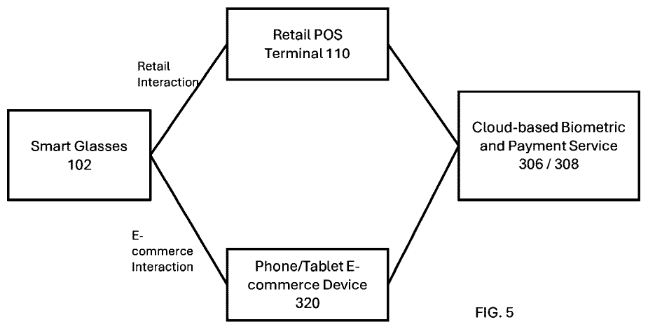

FIG. 5 illustrates an example payment environment 300. The smart glasses 102 communicate over a local wireless link 302 with a retail POS terminal 110, for example using Bluetooth or near field communication (NFC). The POS terminal 110 is connected to a payment processing network 304 that includes a cloud-based biometric and payment service 306 and one or more issuer or acquirer systems 308. In a retail scenario, the POS terminal 110 sends transaction details to the smart glasses 102, receives an authentication result or payment credential back from the smart glasses 102 or the cloud-based service 306, and completes the purchase.

The same smart glasses 102 can also interact with a user-operated e-commerce device 320, such as a mobile phone or tablet. When the user 100 initiates a payment on the device 320, the device 320 sends a confirmation request to the smart glasses 102. The smart glasses 102 capture a palm image, authenticate the user as described herein, and return a confirmation token to the device 320. The device 320 then proceeds to complete the online transaction with the payment processing network 304.

In one embodiment, biometric matching is performed locally on the smart glasses 102. The controller 200 extracts palm feature vectors from the captured palm images and compares them to locally stored palm templates in the secure element 218. If the match score exceeds a predetermined match threshold, the controller 200 instructs the secure element 218 to generate a signed authentication token bound to the transaction. The token is sent either to the POS terminal 110 or to the payment service 306 via the wireless communication module 212.

In another embodiment, the smart glasses 102 transmit at least one raw palm image, or a compressed or encrypted version of the raw palm image, to the cloud-based biometric and payment service 306. The cloud-based service 306 performs biometric matching using stored templates and returns an authentication result to the smart glasses 102 or directly to the POS terminal 110 or e-commerce device 320. This embodiment allows more computationally intensive matching algorithms to be employed in the cloud while the smart glasses 102 handle image capture and secure transport of the palm images.

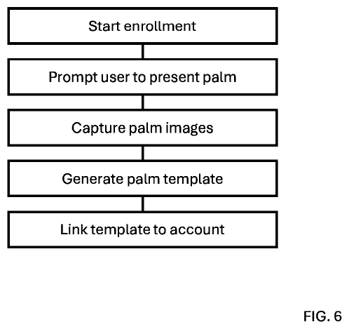

FIG. 6 depicts an embodiment of an enrollment process. At the start enrollment block, the smart glasses 102 enter an enrollment mode in response to a user request or an instruction from the payment service 306. At the prompt user to present palm block, the smart glasses 102 display instructions prompting the user to present the palm 104 at various orientations and distances. At capture palm images block, the palm imaging subsystem captures a sequence of palm images under one or more illumination conditions. At the generate palm template block, the images are processed to segment the palm and extract features for identification. At the link template account block, a palm biometric template is generated from the features and associated with a user identifier and one or more payment accounts for use later as an authentication template associated with the user/account.

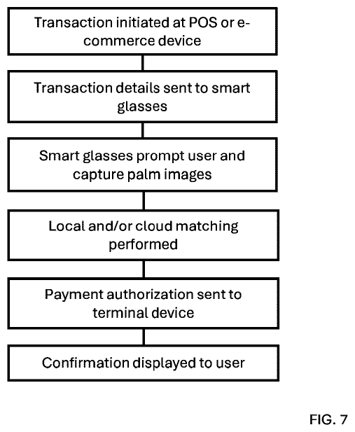

FIG. 7 depicts an embodiment of a payment authorization process. At the transaction initiated at POS or e-commerce device block, a transaction is initiated at the retail POS terminal 110 or the e-commerce device 320. At the transaction details sent to smart glasses block, transaction details are sent to the smart glasses 102. At smart glasses prompt user and capture palm images block, the smart glasses 102 display the merchant and amount of the transaction and prompt the user 100 to present the palm 104. At local and/or cloud matching performed block, the palm imaging subsystem captures the users'palm images. At the payment authorization sent to terminal or device block, local and/or cloud-based biometric matching is performed as described above by comparing the live images to the users stored template images. At the confirmation displayed to user block, a payment token or authorization result is transmitted to the payment network 304 assuming a match is found, and a confirmation is presented to the user 100 in the smart glasses display and, where applicable, on the POS terminal 110 or e-commerce device 320.

FIG. 8 schematically illustrates an example wearer-perspective field of view 600 as rendered by the smart glasses 102. The wearer sees a portion of the physical environment, such as a counter surface or a merchant area, with an outline of the user's own palm 104 visible in the lower portion of the field of view. An augmented reality overlay 602 displays a merchant name, a transaction amount, and a palm positioning guide such as a box or outline into which the palm should be aligned. After successful authentication, the overlay 602 may change to show a check mark or approval message, indicating that the payment has been authorized.

Although the embodiments illustrated show a single user, the smart glasses 102 can be configured to support multiple users, with distinct palm templates and accounts stored for each user. User selection may be performed based on which palm template matches the captured palm, or based on a user profile selection presented in the display.

Various combinations of RGB-only, NIR-only, and multi-spectral palm imaging can be implemented in the same hardware platform. For example, a base model of the smart glasses 102 may include only an RGB palm camera 204, while a higher-end model includes both the RGB palm camera 204 and the NIR camera 206 and illumination sources 208. The software can expose configuration options or automatically select imaging modes based on ambient light and security policy.

The described systems may incorporate additional safeguards such as monitoring for unusual transaction patterns, limiting transaction amounts for palm-only authentication versus multi-modal authentication, and requiring a secondary factor (for example, a spoken passphrase or a tap gesture on the frame) for high-risk transactions. Privacy controls may allow the user to restrict whether raw palm images are ever uploaded to the cloud-based service 306 or whether only derived feature vectors are shared.

While specific examples have been provided, the invention is not limited to the particular arrangements shown. Modification and variations will occur to persons of ordinary skill in the art. The scope of the invention is defined by the claims.

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure may be described herein with reference to flowchart illustrations and/or block diagrams of methods, apparatuses (systems), and computer program products according to embodiments of the disclosure. It will be understood that some blocks of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

References to computer-readable media generally includes all types of computer-readable media, including magnetic storage media, optical storage media, and solid-state storage media. It should be understood that any software may be installed in and sold with the device. Alternatively, the software may be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) can be accessed by a computing device and/or processor(s), and include volatile and non-volatile internal and/or external media that is removable and/or non-removable. For computing devices, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in any appended claims is not necessarily limited to the specific features or acts described above. Rather, the specific features and acts described above are disclosed as example forms of implementing any claims.

1. A smart glasses device configured to authorize a payment transaction, comprising:
a frame configured to be worn on a head of a user;
a see-through display supported by the frame and positioned within a field of view of the user;
a palm imaging camera mounted to the frame and oriented to capture images of an inner surface of a palm of the user when the user presents the palm within a capture zone in front of the smart glasses device;
at least one illumination source positioned proximate to the palm imaging camera;
a wireless communication interface configured to exchange data with a retail point-of-sale terminal;
at least one processor; and
at least one memory storing executable instructions and palm biometric template data associated with a payment account of the user;
wherein the at least one processor is configured by the executable instructions to:
receive, via the wireless communication interface from the retail point-of-sale terminal, transaction data defining the payment transaction;
cause the see-through display to present a prompt instructing the user to present the inner surface of the palm within the capture zone;
capture, using the palm imaging camera, one or more palm images of the inner surface of the palm while the inner surface of the palm is within the capture zone;
derive biometric feature data from the one or more palm images;
compare the biometric feature data to the palm biometric template data to determine whether the palm corresponds to the user; and
in response to determining that the palm corresponds to the user, provide, via the wireless communication interface, a payment authorization message toward at least one of the retail point-of-sale terminal or a payment service involved in processing the payment transaction.

2. The smart glasses device of claim 1, wherein the palm imaging camera comprises a visible-light RGB camera and the biometric feature data represents palm texture and ridge features derived from RGB image data.

3. The smart glasses device of claim 1, further comprising a near-infrared (NIR) imaging sensor and an NIR illumination source, wherein the at least one processor is further configured to capture NIR palm images and to derive the biometric feature data at least in part from palm vein patterns visible in the NIR palm images.

4. The smart glasses device of claim 1, wherein the at least one processor is configured, in a first mode of operation, to perform the comparison of the biometric feature data to the palm biometric template data locally on the smart glasses device and to generate a signed authentication token for the payment transaction without transmitting the one or more palm images to the payment service.

5. The smart glasses device of claim 1, wherein the at least one processor is configured, in a second mode of operation, to transmit at least one of the one or more palm images from the smart glasses device to a cloud-based biometric matching server operated by or on behalf of the payment service, and to receive from the cloud-based biometric matching server an authentication result indicating whether the palm corresponds to the user.

6. The smart glasses device of claim 1, further comprising a wireless communication interface configured to exchange data with a retail point-of-sale terminal, wherein the payment authorization message is provided to the retail point-of-sale terminal to complete an in-person payment transaction at the retail point-of-sale terminal.

7. The smart glasses device of claim 1, wherein the wireless communication interface is configured to exchange data with a user-operated phone or tablet, and wherein the payment authorization message is provided to the user-operated phone or tablet to complete an electronic commerce payment transaction initiated on the user-operated phone or tablet.

8. The smart glasses device of claim 1, wherein the see-through display is configured to present an augmented reality payment interface including at least a merchant identifier, a transaction amount, and a palm positioning guide while the palm imaging camera captures the one or more palm images.

9. The smart glasses device of claim 1, further comprising a secure element configured to store the palm biometric template data and at least one cryptographic key, wherein the at least one processor is configured to request that the secure element generate a cryptographically signed token bound to the payment transaction upon determining that the palm corresponds to the user.

10. A payment system comprising:
a frame configured to be worn on a head of a user;
a see-through display supported by the frame and positioned within a field of view of the user;
a palm imaging camera mounted to the frame and oriented to capture images of an inner surface of a palm of the user when the user presents the palm within a capture zone in front of the smart glasses device;
at least one illumination source positioned proximate to the palm imaging camera;
a wireless communication interface configured to exchange data with a retail point-of-sale terminal;
at least one processor;
at least one memory storing executable instructions and palm biometric template data associated with a payment account of the user;
a retail point-of-sale terminal configured to initiate payment transactions and to communicate with a payment processing network;
wherein the retail point-of-sale terminal is configured to transmit transaction data to a smart glasses device, and
wherein, in response to the smart glasses device determining that the palm corresponds to the user, the smart glasses device or the payment processing network provides payment authorization data to the retail point-of-sale terminal to complete a payment transaction.

11. The payment system of claim 10, wherein the retail point-of-sale terminal and the smart glasses device communicate via a local wireless link selected from the group consisting of Bluetooth, Wi-Fi, and NFC.

12. The payment system of claim 10, wherein the payment processing network includes a cloud-based biometric matching server configured to receive raw palm images from the smart glasses device, perform biometric matching using stored palm templates, and provide an authentication result used to authorize the payment transaction.

13. A payment system comprising:
a frame configured to be worn on a head of a user;
a see-through display supported by the frame and positioned within a field of view of the user;
a palm imaging camera mounted to the frame and oriented to capture images of an inner surface of a palm of the user when the user presents the palm within a capture zone in front of the smart glasses device;
at least one illumination source positioned proximate to the palm imaging camera;
a wireless communication interface configured to exchange data with a retail point-of-sale terminal;
at least one processor;
at least one memory storing executable instructions and palm biometric template data associated with a payment account of the user;
a user-operated device comprising at least one of a mobile phone or tablet configured to perform an electronic commerce checkout process;
wherein the user-operated device is configured to request biometric confirmation from the smart glasses device for a pending payment transaction, and
wherein the smart glasses device is configured, upon determining that the palm corresponds to the user, to transmit an authentication token to the user-operated device to permit completion of the pending payment transaction.

14. A computer-implemented method of authorizing a payment transaction using smart glasses worn by a user, the method comprising:
receiving, at the smart glasses, transaction data defining a payment transaction initiated at either a retail point-of-sale terminal or a user-operated e-commerce device;
presenting, on a see-through display of the smart glasses, a prompt instructing the user to present an inner surface of a palm within a capture zone;
capturing, using a palm imaging camera mounted to a frame of the smart glasses, one or more palm images of the inner surface of the palm while the inner surface of the palm is within the capture zone;
deriving, using at least one processor, biometric feature data from the one or more palm images;
comparing the biometric feature data to palm biometric template data stored for the user to determine whether the palm corresponds to the user; and
in response to determining that the palm corresponds to the user, transmitting a payment authorization message associated with the payment transaction.

15. The method of claim 14, further comprising performing the comparing locally on the smart glasses in a first mode of operation and transmitting at least one raw palm image from the smart glasses to a cloud-based biometric matching server to perform the comparing in a second mode of operation.

16. The method of claim 14, wherein receiving the transaction data comprises receiving the transaction data from a retail point-of-sale terminal and wherein transmitting the payment authorization message comprises providing a payment credential from the smart glasses to the retail point-of-sale terminal to complete an in-person transaction.

17. The method of claim 14, wherein receiving the transaction data comprises receiving the transaction data from a user-operated phone or tablet and wherein transmitting the payment authorization message comprises providing an authentication token to the user-operated phone or tablet to complete an e-commerce transaction.

18. The method of claim 14, wherein deriving the biometric feature data comprises processing RGB palm images captured by an RGB camera on the smart glasses, and wherein the method further comprises, in another operating mode, capturing NIR palm images and deriving the biometric feature data at least in part from the NIR palm images.

19. A non-transitory computer-readable medium storing instructions which, when executed by one or more processors of smart glasses, cause the smart glasses to perform the method of any one of claims 14 to 18.

20. The smart glasses device of claim 1, wherein the smart glasses device is configured to operate in a palm-only authentication mode in which payment transactions are authorized based solely on matching of palm images captured by the palm imaging camera without requiring capture of facial images of the user.
